(19) United States
(12) Patent Application Publication
(10) Pub. No.: US 2015/0007181 A1
(43) Pub. Date: Jan. 1, 2015

(54) METHOD AND SYSTEM FOR SELECTING TASK TEMPLATES

(71) Applicant: XEROX CORPORATION, Norwalk, CT (US)

(72) Inventors: Karanam Saraschandra, Bangalore (IN); Koustuv Dasgupta, Hebbal (IN); Harini Alagarai Sampath, Chennai (IN); Vaibhav Rajan, Kammanahalli (IN); Bipin Indurkhya, Krakow (PL)

(21) Appl. No.: 13/928,709

(22) Filed: Jun. 27, 2013

(51) Int. Cl. G06F 9/46

(52) U.S. Cl. CPC G06F 9/46
USPC 718/100

(57) ABSTRACT

Disclosed embodiments relate to systems and methods for selecting at least one task template from one or more task templates for uploading crowdsourcing tasks. Values of a pre-defined set of cognitive features associated with one or more task templates are determined. Further, a historical data is obtained based on one or more task features and one or more performance features corresponding to the one or more task templates. A statistical model selects the at least one task template based on the values of the pre-defined set of cognitive features and the historical data.

### TECHNICAL FIELD

The presently disclosed embodiments are related to crowdsourcing. More particularly, the presently disclosed embodiments are related to methods and systems for selecting at least one task template from one or more task templates.

### BACKGROUND

Crowdsourcing has emerged as a convenient and economical method for organizations to outsource certain tasks, which require human involvement. For example, tasks such as digitization of a handwritten document, labeling of an image, and anomaly detection in a video may be uploaded by a requester on one or crowdsourcing platforms, from where crowdworkers associated with the crowdsourcing platforms may attempt the tasks.

Usually, the requester uploads the tasks on the crowdsourcing platform using one or more task templates. A typical task template may include instructions about how to perform the tasks and necessary data, or links to the data, to be processed by crowdworkers. The crowdworkers refer to the instructions and the data/links to perform the tasks. Thus, the design of the task templates i.e. the ways in which the instructions and/or the data/links are presented may have direct impact on the quality of the tasks performed by the crowdworkers. For example, a task template with clear instructions about the tasks on what to solve and how to solve would possibly attract high number of accurate answers. On the other hand, a poorly defined task template would possibly receive random/erroneous responses from the crowdworkers.

### SUMMARY

According to embodiments illustrated herein, there is provided a method for selecting at least one task template from one or more task templates. The method includes determining values of a pre-defined set of cognitive features associated with each of the one or more task templates. In addition, the method includes selecting the at least one task template based on the pre-defined set of cognitive features and a statistical model maintained based on a historical data, the historical data corresponding to at least one of one or more task features or one or more performance features associated with the one or more task templates. The method is performed by one or more processors.

According to embodiments illustrated herein there is provided a system for selecting at least one task template from one or more task templates. The system includes a memory and one or more processors. The memory includes a communication manager, a feature determination module, and a statistical model. The communication manager is configured to receive the one or more task templates corresponding to the one or more crowdsourcing tasks. The feature determination module is configured to determine values of a pre-defined set of cognitive features associated with each of the one or more task templates. Further, the statistical model is configured to select the at least one task template based on the values of the pre-defined set of cognitive features and a historical data, the historical data corresponding to at least one of one or more task features or one or more performance features associated with the one or more task templates. The one or more processors are configured to execute the set of instructions in the communication manager, the feature determination module, and the statistical model.

According to embodiments illustrated herein, there is provided a computer program product for use with a computer. The computer program product includes a computer readable medium storing a computer-readable program code embodied therein for selecting at least one task template from one or more task templates. The computer-readable program code performs: determining values of a pre-defined set of cognitive features associated with each of the one or more task templates; selecting the at least one task template based on the values of the pre-defined set of cognitive features and a statistical model maintained based on a historical data. The historical data corresponds to at least one of one or more task features or one or more performance features associated with the one or more task templates.

### BRIEF DESCRIPTION OF DRAWINGS

The accompanying drawings illustrate various embodiments of systems, methods, and various other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a system environment in which various embodiments may be implemented;

FIG. 2 is a block diagram illustrating a system for selecting at least one task template from one or more task templates in accordance with at least one embodiment;

FIG. 3 is a flow diagram illustrating a method for creating a statistical model in accordance with at least one embodiment;

FIG. 4 is a flow diagram illustrating a method for selecting at least one task template from one or more task templates in accordance with at least one embodiment; and

FIGS. 5a, 5b, and 5c illustrate example task templates in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as methods and systems may extend beyond the described embodiments. For example, the learning presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

“Crowdsourcing” refers to distributing tasks by soliciting the participation of defined groups of users. A group of users may include, for example, individuals responding to a solicitation posted on a certain website (e.g., crowdsourcing platform), such as Amazon Mechanical Turk or Crowd Flower.

A “crowdsourcing platform” refers to a business application, wherein a broad, loosely defined external group of people, community, or organization provides solutions as outputs for any specific business processes received by the application as input. In an embodiment, the business application may be hosted online on a web portal. Various examples of the crowdsourcing platforms include, but are not limited to, Amazon Mechanical Turk or Crowd Flower.

A “crowdworker” refers to a worker or a group of workers that may perform one or more crowdsourcing tasks that generate data that contribute to a defined result, such as proofreading part of a digital version of an ancient text or analyzing a small quantum of a large volume of data. Hereinafter, “worker”, “crowdsourced workforce,” “crowdworker,” “crowd workforce,” and “crowd” may be interchangeably used.

A “task template” refers to a template that includes instructions about how to perform the tasks. Further, the task template may include data, or a link to the data, to be processed by the crowdworkers. In an embodiment, the crowdworkers may refer to the instructions and the data/links to perform the tasks. In addition, the task template may also include response regions, where the crowdworkers can provide responses corresponding to the tasks.

“Task features” refer to the properties associated with the one or more crowdsourcing tasks. Examples of the task features may include, but are not limited to, a day of submitting the crowdsourcing task, a time in the day of submitting the crowdsourcing task, a cost of the crowdsourcing task, a country of crowdworker and so forth.

“Performance features” refer to one or more characteristics associated with the performance of the one or more task templates. The examples of the performance features may include, but are not limited to, an accuracy rate for the crowdsourcing tasks, a response time for the crowdsourcing tasks, or a completion rate for the crowdsourcing tasks.

“Cognitive Features” refer to features that take into account various characteristics of humans such as perception, language, memory, reasoning, emotions, and the like. Various examples of cognitive features associated with the one or more task templates may include a saliency, search efficiency, a target-distracter similarity, a distracter-distracter similarity, a task description similarity, domain knowledge, and a working memory.

“Saliency” corresponds to a property of the one or more task templates to grab attention of the crowdworkers. The saliency in the task template may correspond to features such as color used in the task template, image contrast in the task template, orientation of the task template and the type of task included in the task template. For example, in order to improve the saliency for any task template, one or more areas (e.g., areas including the data to be processed by the crowdworkers) in the task template can be highlighted to grab attention of the crowdworkers.

“Search Efficiency” corresponds to a relationship between the data be processed by the crowdworkers and the total data available in the task template. As an example, in the task of digitization of a handwritten medical insurance form, where the task involves digitization of a number of fields (e.g., name, address, etc.), the search efficiency may correspond to a ratio of the number of fields to be digitized (e.g., name, address, etc.) to the total number of fields available in the task template.

“Target-distracter similarity” refers to semantic similarity between data to be processed by the crowdworkers and rest of data available in the task template. Considering the example of the digitization task, the target-distracter similarity may refer to semantic similarity between target fields (i.e., the fields that are to be digitized by the crowdworkers) and rest of fields in the task template. In a similar way, a “distracter-distracter similarity” refers to the semantic similarity between the data that is not to be processed by the crowdworkers. Higher the value of the target-distracter similarity, lower will be the performance of the crowdworkers performing the task. Similarly, higher the value of the distracter-distracter similarity, higher will be the performance of the crowdworkers.

“Task description similarity” refers to a way in which the tasks to be performed are described in the task template. The more descriptive the task template will be, with respect to the task, higher will be the value of the task description similarity.

“Domain knowledge” corresponds to the presence of the hints/examples in the task template while the task is attempted by the crowdworkers. In an embodiment, the “domain knowledge” is a categorical variable and takes only two values: 1, if examples/hints are available in the task template for performing the task and 0, otherwise.

“Working memory” corresponds to the information processing capability of the crowdworkers while performing the task. With reference to ongoing description, the working memory may be utilized by splitting the data to be processed by the crowdworkers so that the crowdworkers have to process less information to complete the tasks. For example, in the task of digitization where the crowdworkers have to digitize an alphanumeric ID number, the task can be split in two parts to digitize the numbers and the alphabets separately.

“Sample crowdsourcing tasks” refer to the one or more crowdsourcing tasks uploaded on the one or more crowdsourcing platforms using each of the one or more task templates. The one or more sample crowdsourcing tasks are uploaded for obtaining a historical data comprising at least one of the task features or the performance features associated with each of the one or more task templates.

It would be understood by a person having ordinary skills in the art that the examples/embodiments used while defining the above terms are for illustration purposes only and the definitions can be applied to other embodiments/examples without deviating from the scope of the ongoing description.

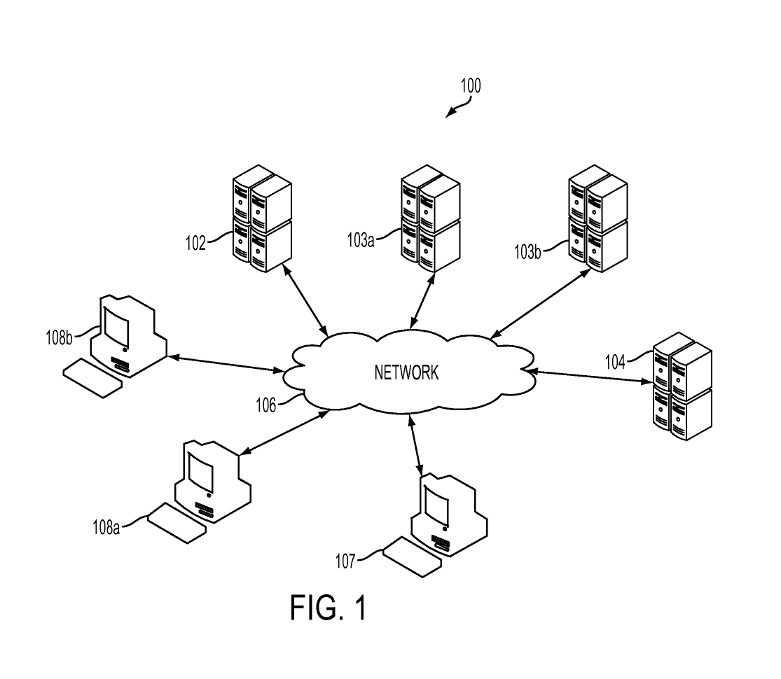

FIG. 1 is a block diagram illustrating a system environment 100 in which various embodiments may be implemented. Various embodiments of methods and systems for selecting at least one task template from one or more task templates are implementable in the system environment 100. The system environment 100 includes an application server 102, crowdsourcing platform servers 103a and 103b (hereinafter referred to as crowdsourcing platform servers 103), a database server 104, a network 106, a requester-computing device 107 and worker-computing devices 108a and 108b (hereinafter referred to as worker-computing devices 108). The application server 102, the crowdsourcing platform servers 103, the database server 104, the requester-computing device 107, and the worker-computing devices 108 are interconnected over the network 106.

FIG. 1 shows, for simplicity, only one application server 102 and only one database server 104. However, it will be apparent to a person having ordinary skill in the art that the disclosed embodiments may also be implemented using multiple applications servers 102 and multiple database servers 104. In an embodiment, a crowdworker may perform the tasks using a variety of computing devices, other than shown worker-computing device 108, such as a laptop, a personal digital assistant (PDA), a tablet computer (e.g., iPad®, and Samsung Galaxy Tab®), and the like.

The application server 102 is capable to host an application/tool/framework for selecting the at least one task template from the one or more task templates in accordance with at least one embodiment. As the application server 102 is interconnected with the requester-computing device 107, the worker-computing devices 108, and the crowdsourcing platform servers 103, any information pertaining to the crowdsourced tasks received from the requester goes to the crowdworkers via the crowdsourcing platform servers 103.

In an embodiment, the requester may access the application server 102 and submit the one or more task templates. In this case, the requester accesses the application server 102 over the network 106 to submit the one or more task templates (may be through a web-based interface), which may be used to create one or more sample crowdsourcing tasks. Some examples of the application server 102 may include, but not limited to, Java application server, .NET framework, and Base4 application server.

The crowdsourcing platform servers 103 are devices or computers that host one or more crowdsourcing platforms. One or more crowdworkers are associated with the crowdsourcing platform. Further, the crowdsourcing platform servers 103 offer the one or more tasks to the one or more crowdworkers. In an embodiment, the crowdsourcing platform servers 103 present user interface (UI) to the one or more crowdworkers through a web based interface or a client application. The one or more crowdworkers may access the one or more tasks through the web based interface or the client application. Further, the one or more crowdworkers may submit a final work product/response to the crowdsourcing platform through the web based interface. In an embodiment, the crowdsourcing platform servers 103 receive the one or more tasks from the application server 102 and transmit the tasks to the crowdworkers. In an alternate embodiment, the crowdsourcing platform servers 103 may itself host the application to select the at least one task template from the one or more task templates. The crowdsourcing platform servers 103 may be realized through an application server such as, but not limited to, Java application server, .NET framework, and Base4 application server.

In yet another embodiment, the application for selecting the at least one task template from the one or more task templates may also be installed on the requester-computing devices 107 without limiting the scope of the invention.

The database server 104 may refer to a device or a computer that maintains a repository of the tasks assigned to the crowdworkers. In an embodiment, the database server 104 may store one or more task features or the one or more performance features associated with the one or more task templates. The one or more performance features may be obtained by uploading the one or more sample crowdsourcing tasks corresponding to each of the one or more task templates. The database server 104 may receive a query from the application server 102 or the crowdsourcing platform servers 103 to retrieve the data pertaining to the tasks. For querying the database server 104, one or more querying languages may be utilized such as, but are not limited to, SQL, QUEL, DMX and so forth. Further, the database server 104 may be realized through various technologies, such as, but not limited to, Microsoft® SQL server, Oracle, and My SQL. In an embodiment, the application server 102 or the crowdsourcing platform servers 103 may be connected to the database server 104 using one or more protocols such as, but not limited to, ODBC protocol and JDBC protocol.

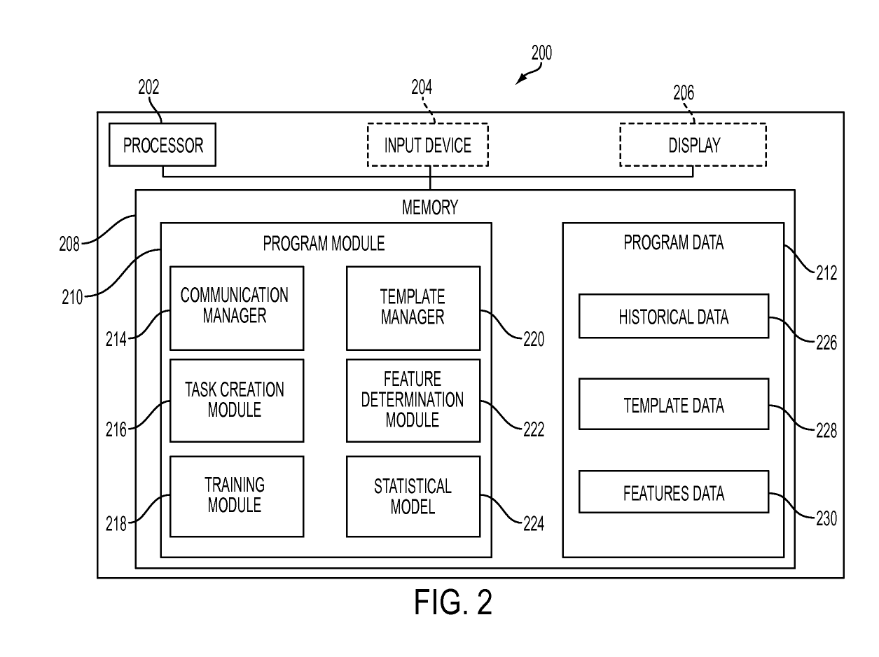

A person skilled in the art would understand that the scope of the disclosure should not be limited to the database server 104 as a separate entity. In an embodiment, embodiment, the functionalities of the application server 102 and the database server 104 may be combined into a single server (as described in FIG. 2), without limiting the scope of the inventions. In an alternate embodiment, functionalities of the application server 102 and the database server 104 may be integrated into the crowdsourcing platform servers 103.

The network 106 corresponds to a medium through which content and messages flow between various devices of the system environment 100 (e.g. the worker-computing devices 108, the database server 104, the application server 102, the crowdsourcing platform servers 103, and the requester-computing devices 107). Examples of the network 106 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 106 in accordance with the various wired and wireless communication protocols such as Transmission Control Protocol and Internet Protocol (TCP/IP), User Datagram Protocol (UDP), and 2G, 3G, or 4G communication protocols.

FIG. 2 is a block diagram illustrating a system 200 for selecting the at least one task template from the one more task templates in accordance with at least one embodiment. The system 200 includes a processor 202, an input device 204, a display 206, and a memory 208. In an embodiment, the system 200 may correspond to any of the requester-computing device 107, the application server 102, or the crowdsourcing platform server 103 without departing from the scope of the disclosure.

The processor 202 is coupled to the input device 204, the display 206, and the memory 208. The processor 202 executes a set of instructions stored in the memory 208 to perform one or more operations. The processor 202 may be realized through a number of processor technologies known in the art. Examples of the processor 202 include, but are not limited to, an X86 processor, a RISC processor, an ASIC processor, a CISC processor, ARM processor, or any other processor.

In an embodiment, the input device 204 receives an input to upload the tasks on the system 200. Examples of the input device 204 include, but are not limited to, a mouse, a keyboard, a touch panel, a track-pad, a touch screen, or any other device that has the capability of receiving the user input.

In an embodiment, the display 206 displays one or more interfaces for uploading the tasks on the system 200. The display 206 may be realized through several known technologies, such as, a Cathode Ray Tube (CRT) based display, a Liquid Crystal Display (LCD), a Light Emitting Diode (LED)-based display, an Organic LED display technology, and a Retina Display technology. Further, the display 206 can be a touch screen that receives the user input.

The memory 208 stores a set of instructions and data. Some of the commonly known memory implementations include, but are not limited to, a random access memory (RAM), a read only memory (ROM), a hard disk drive (HDD), and a secure digital (SD) card. Further, the memory 208 includes a program module 210 and a program data 212. The program module 210 includes a set of instructions that is executable by the processor 202 to perform various operations. The program module 210 further includes a communication manager 214, a task creation module 216, a training module 218, a template manager 220, a feature determination module 222, and a statistical model 224. It will be apparent to a person having ordinary skill in the art that the set of instructions stored in the memory 208 enables the hardware of the system 200 to perform the predetermined operation.

The program data 212 includes a historical data 226, a template data 228, and a feature data 230.

The communication manager 214 is configured to receive the one or more task templates. The one or more task templates may be received from the requester over the network 106. The data pertaining to the one or more task templates may be stored in the memory 208 as the template data 228. In an embodiment, the communication manager 214 is further configured to transmit the one or more sample crowdsourcing tasks to the crowdsourcing platform servers 103, from where the one or more sample crowdsourcing tasks may be attempted by the one or more crowdworkers. In an alternate embodiment, the communication manager 214 transmits the one or more sample crowdsourcing tasks to worker-computing device 108. In addition, the communication manager 214 is configured to receive responses corresponding to the one or more sample crowdsourcing tasks. In an embodiment, the responses may be used to determine the one or more performance features and the one or more task features. The communication manager 214 may include various protocol stacks such as, but not limited to, Transmission Control Protocol and Internet Protocol (TCP/IP), User Datagram Protocol (UDP), 2G, 3G or 4G communication protocols. The communication manager 214 transmits and receives the messages/data in accordance with such protocol stacks.

The task creation module 216 is configured to create the one or more sample crowdsourcing tasks. In an embodiment, the one or more sample crowdsourcing tasks are created using each of the one or more task templates. In an embodiment, while creating the one or more sample crowdsourcing tasks, the task creation module 216 embeds necessary information for the crowdworkers such as cost of the one or more sample crowdsourcing tasks, instructions about how to perform the one or more sample crowdsourcing tasks, and expected time of completion of the one or more sample crowdsourcing tasks.

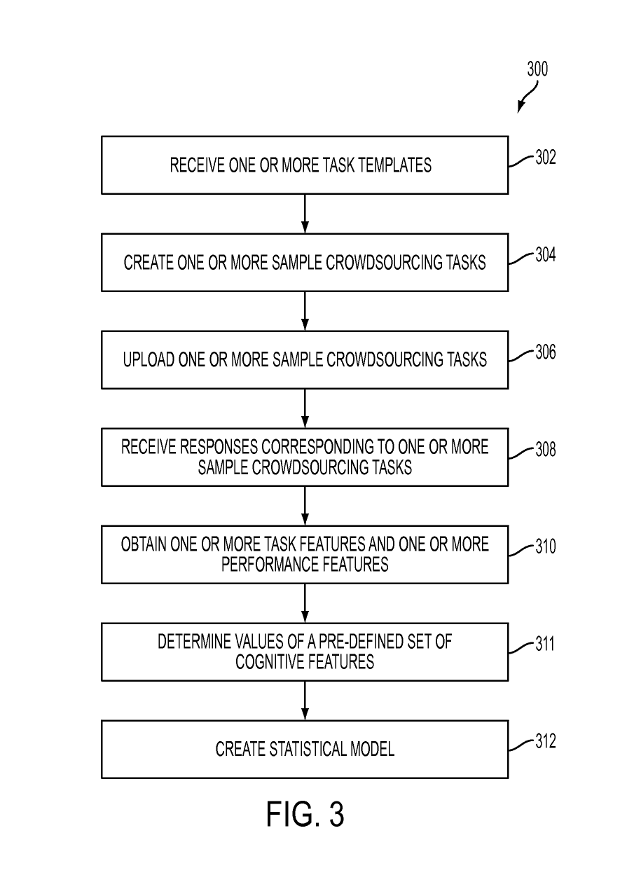

The training module 218 is configured to create the statistical model 224 based on the historical data 226. In an embodiment, after the historical data 226 corresponding to the one or more sample crowdsourcing tasks is obtained by the communication manager 214, the training module 218 creates the statistical model 224. The training module 218 is further configured to update the statistical model 224 based on at least one of the one or more task features, the one or more performance features, or values of a pre-defined set of cognitive features associated with the one or more task templates. The creation and updating of the statistical model 224 is described later in conjunction with FIG. 3.

The template manager 220 is configured to identify the pre-defined set of cognitive features in the one or more task templates. In an embodiment, after the one or more task templates are received by the communication manager 214, the template manager 220 may access the template data 228 to identify the pre-defined set of cognitive features, such as, highlighting of the one or more areas in the one or more task templates, data to be processed, hints/examples available in the task description, and so forth.

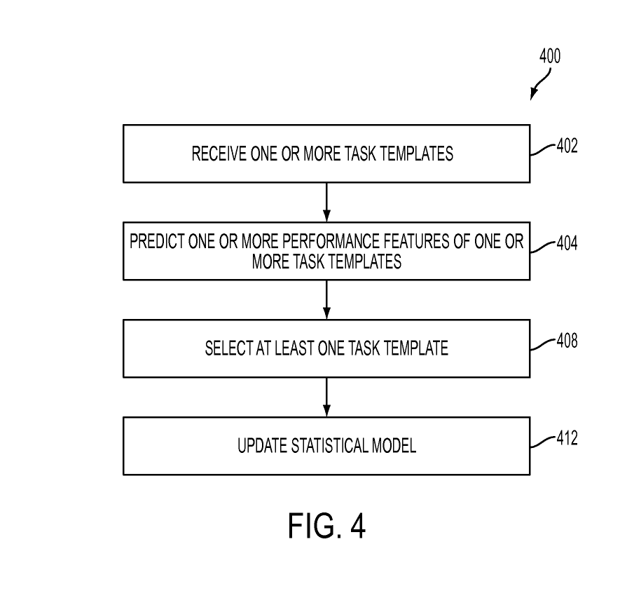

The feature determination module 222 is configured to determine the values of the pre-defined set of cognitive features associated with the one or more task templates. In an embodiment, after the pre-defined set of cognitive features is identified by the template manager 220, the feature determination module 222 calculates the numerical values associated with each of the cognitive features. In an embodiment, the determined values may be stored in the memory 208 as the features data 230. The method of calculating the values of the pre-defined set of cognitive features is described in conjunction with FIG. 4.

The statistical model 224 is configured to select the at least one task template from the one or more task templates. In an embodiment, the statistical model 224 learns the interactions between the historical data 226 and the values of the pre-defined set of cognitive features to predict the one or more performance features of the one or more task templates. In an embodiment, the statistical model 224 may use a regression technique to predict the performance features. Various methods may be used for the regression such as generalized linear models (e.g., linear regression, stochastic gradient descent), kernel methods (e.g., SVM, Gaussian Processes), nearest neighbor methods (e.g., KNN), decision trees (e.g., regression trees), ensemble methods (e.g., random forests, gradient tree boosting), and so forth. Further, the statistical model 224 is configured to select the at least one task template based on the prediction of the performance features.

FIG. 3 is a flow diagram 300 illustrating a method for creating the statistical model 224 in accordance with at least one embodiment. The flow diagram 300 is described in conjunction with FIG. 1 and FIG. 2.

At step 302, the one or more task templates are received. In an embodiment, the one or more task templates may be received by the communication manager 214 over the network 106. As discussed, the requester may access the application server 102 or the crowdsourcing platform servers 103 using the requester-computing device 107 and submit the one or more task templates. The one or more task templates are stored in the memory 208 as the template data 228. In an embodiment, the template data 228 includes data pertaining to cognitive features such as highlighting of the one or more areas in the one or more task templates, data to be processed, hints/examples available for the task description and so forth.

At step 304, the one or more sample crowdsourcing tasks are created. The one or more sample crowdsourcing tasks are created by the task creation module 216 using each of the one or more task templates. In an embodiment, the task creation module 216 accesses the template data 228 in the memory 208 and creates the one or more sample crowdsourcing tasks. Information such as cost of the one or more sample crowdsourcing tasks, instructions about how to perform the one or more sample crowdsourcing tasks, and expected time of completion of the one or more sample crowdsourcing tasks may be included while creating the one or more sample crowdsourcing tasks. Further, in an embodiment, the information about the cognitive features in the one or more task templates is used by the task creation module 216 while creating the one or more sample crowdsourcing tasks (e.g., which areas to highlight in the tasks, what task description to provide, etc.).

In an alternate embodiment, the creation of the one or more sample crowdsourcing tasks may not be necessary and the one or more pre-stored sample crowdsourcing tasks may be used without limiting the scope of the invention.

At step 306, the one or more sample crowdsourcing tasks are uploaded. In an embodiment, the communication manager 214 uploads the tasks to the crowdsourcing platform servers 103, from where the tasks may be attempted by the crowdworkers through the crowdsourcing platforms. In an alternate embodiment, the communication manager 214 transmits the one or more sample crowdsourcing tasks to the worker-computing device 108. Using the information available (e.g. how to perform the tasks) in the task template, the one or more crowdworkers provide responses. In an embodiment, a response region may be provided in the task template where the one or more crowdworkers may provide the responses before submitting them.

At step 308, the responses corresponding to the one or more sample crowdsourcing tasks are received. In an embodiment, the responses are received by the communication manager 214 over the network 106. The examples of the responses may include, but are not limited to, an identified handwritten content, a translated text, a labeled image/video and so forth.

At step 310, the one or more task features and the one or more performance features are obtained. Prior to obtaining the performance features and the task features, the responses corresponding to the one or more sample crowdsourcing tasks are validated. In an embodiment, the responses are compared with correct responses for the one or more sample crowdsourcing tasks to obtain the performance features. In an embodiment, the one or more performance features may include at least one of an accuracy rate for the one or more sample crowdsourcing tasks, a response time for the one or more sample crowdsourcing tasks, or a completion rate for the one or more sample crowdsourcing tasks. In a similar way, the one or more task features such as a day of submitting the task, a time of submitting the task, a cost of the task, or a country of crowdworker may also be obtained corresponding to the responses provided by the one or more crowdworkers.

For example, 100 sample crowdsourcing tasks corresponding to a task of digitization of a handwritten medical insurance form are uploaded (e.g., for each of the three task templates: Template 1, Template 2, and Template 3). If correct responses received for Template 1, Template 2, and Template 3 on Monday are 70, 80, and 90, respectively, (out of 100 responses received for each of the templates), then the accuracy rate for the Template 1, Template 2, and Template 3 will be 70%, 80%, and 90%, respectively. These values, i.e., 70%, 80%, and 90% will be one of the performance features. Similarly, Monday will be one of the task features associated with the three templates. In a similar way, other task features and the performance features may be obtained associated with the one or more task templates. The following table (Table 1) illustrates an example of the performance features and the task features associated with the Template 1, Template 2, and Template 3.

TABLE 1
Illustration of the performance features and the task features

| | Task Features | | Performance Features | |
|---|---|---|---|---|
| | | Cost of the sample | | Response |
| | Day of | crowdsourcing | | Time |
| Template | submission | task | Accuracy | (minutes) |
| Template 1 | Monday | $0.1 | 70% | 20 |
| Template 2 | Monday | $0.2 | 80% | 30 |
| Template 3 | Wednesday | $0.2 | 90% | 25 |

In an embodiment, the communication manager 214 stores the performance features and the task features as the historical data 226.

At step 311, the values of the pre-defined set of cognitive features are determined. In an embodiment, the values of the pre-defined set of cognitive features are determined by the feature determination module 222 and the values are stored as the feature data 230. As discussed previously, the one or more task templates can be characterized by the set of cognitive features. In an embodiment, the cognitive features associated with each of the one or more task templates comprise at least one of a saliency metric (X_{Sal}), a search efficiency metric (X_{SearchEff}), a target-distracter similarity (X_{TDSim}), a distracter-distracter similarity (X_{DDSim}), a task description similarity (X_{TaskDesSim}), a domain knowledge metric (X_{DK}), or a working memory metric (X_{WM}). The features and corresponding calculations are further described below:

Saliency Metric (X_{Sal}): In an embodiment, the saliency metric (X_{Sal}) can be utilized for identifying the attention grabbing property of the one or more task templates. As an example, if one or more areas in the task template corresponding to the digitization task are highlighted, the crowdworkers' attention will be immediately directed to the highlighted areas. Thus, highlighting relevant areas (e.g., areas including the data to be processed) may increase the performance of the crowdworkers performing the digitization task. In an embodiment, SignatureSaliency is used to determine a saliency map corresponding to the one or more task templates. For each color channel (xⁱ), saliency map “m” is determined by smoothing the squared image signature ( x̅), corresponding to the one or more task templates, with a Gaussian blurring kernel (g) and summing the products:

m=g*Σᵢ x̅ⁱ∘ x̅ⁱ

where,
Image signature x̅=IDCT[sign(\hat{x})], and
\hat{x}=DCT(x).

If I(x,y) denotes the image corresponding to a particular task template, and M(x,y) denote the corresponding saliency map determined as described above, then the saliency metric (X_{Sal}) will be determined by the below equation:

$${X}_{Sal} = \frac{{\sum }_{Target} M ( x , y )}{{\sum }_{Image} M ( x , y )}$$

where,
Σ_{Target}M(x, y) corresponds to the saliency map of the area in the template comprising the data to be processed by the crowdworker, and
Σ_{image}M(x, y) corresponds to the saliency map of the complete task template.

In an embodiment, the X_{Sal} will take the value “0” when all the salient (e.g., highlighted) regions lie outside the target area (e.g., area including the data to be processed by the crowdworker in the task of digitization) in the task template and will take the value “1” when the target area is the only salient region in the task template. Search Efficiency Metric (X_{SearchEff}): In an embodiment, the search efficiency metric (X_{SearchEff}) is defined as:

$${X}_{SearchEff} = \frac{{η}_{T}}{{η}_{N}}$$

where,
η_{T} refers to the number of fields in the task template which are to be digitized by the crowdworker, and
η_{N} refers to the total number of fields in the task template.

As an example, in the task of the digitization, if the task template comprises 32 total numbers of fields, and the number of fields to be digitized by the crowdworker are 4, then X_{SearchEff} will be 4/32=0.125.

Target-Distracter Similarity (X_{TDSim}) and Distracter-Distracter Similarity (X_{DDSim}): As defined, the target-distracter similarity (X_{TDSim}) and the distracter-distracter (X_{DDSim}) correspond to the semantic similarity of the data in the one or more task templates. In an embodiment, Latent Semantic Analysis (LSA) is used to determine the similarity values. LSA constructs a words-by-document matrix, normalizes it with term frequency and inverse document frequency values, and employs singular decomposition to reduce the dimensions to about 300. Further, words and documents are represented as vectors and the cosine value between them given the semantic similarity. A cosine value of +1 denotes identical texts and values near 0 denote unrelated texts. In an embodiment, the LSA operation may be defined as:

$$LSA ( {D}_{i} , {D}_{j} ) = \frac{{D}_{i} ∘ {D}_{j}}{\vert {D}_{i} \vert \vert {D}_{j} \vert}$$

As an example, if one target field is denoted by Target in the task template and M distracter fields are denoted by distracter, a set of distance measures is defined as:

dⱼ=LSA(Target, distracterⱼ), 1≦j≦M

Further, the target-distracter similarity (X_{TDSim}) and distracter-distracter similarity (X_{DDSim}) values for the task templates are determined as:

$$\begin{matrix}{X}_{TDSim} = Max [ {\sum }_{j = 1}^{M} {d}_{j} ] , and \\ {X}_{DDSim} = \frac{1}{( \begin{matrix}M \\ 2\end{matrix} )} {\sum }_{i , j = 1 \\ i != j}^{M} {d}_{i} {d}_{j}\end{matrix}$$

Task Description Similarity (X_{TaskDesSim}): It has been proved by cognitive theories that the way in which description of a task is provided to a human can have a marked impact on the performance of the person performing the task. Considering the example of the digitization task for a handwritten medical form, in which the crowdworkers have to identify the patient's name, the crowdworkers can be provided with different ways to perform the task such as: (i) Digitize the field: PATIENT'S LEGAL NAME, (ii) Digitize the name of the person who is ill, (iii) Digitize the field number 2. In an embodiment, in which the task description is denoted by TaskDescription and the target field in the task template is denoted by TargetField, the task description similarity (X_{TaskDesSim}) is determined as:

X_{TaskDesSim}=LSA(TaskDescription, TargetField)

Domain Knowledge Metric (X_{DK}): In an embodiment, the domain knowledge metric (X_{DK}) corresponds to the presence of the hints/examples in the task template. Further, in an embodiment, the domain knowledge metric (X_{DK}) is a categorical variable that takes two values: 1, if the task provides additional help in the form of the hints/examples and 0 otherwise. Thus:

$${X}_{DK} = \{ \begin{matrix}1 , & hints / examples available \\ 0 , & hints / examples not available\end{matrix}$$

Working memory metric (X_{WM}): According to the cognitive theories known in the art, working memory of a human cannot process too many instructions simultaneously. Taking reference of these theories in the crowdsourcing tasks, the working memory metric (X_{WM}) relates to the information processing required by the crowdworker while performing the task. In an embodiment, the task to be completed by the crowdworkers can be split such that the crowdworkers need to hold less information in the working memory to complete the task. In an embodiment, the feature working memory metric (X_{WM}) is determined as:

$${X}_{DK} = \{ \begin{matrix}1 , & target fields splitted \\ 0 , & target fields not splitted\end{matrix}$$

At step 312, the statistical model 224 is created. In an embodiment, the statistical model 224 is created by determining a statistical relationship between the values of the pre-defined set of cognitive features (stored as the features data 230) and the historical data 226 (i.e., the one or more performance features and the one or more task features). In an embodiment, a regression technique is used to determine the statistical relationship. Various types of the regression techniques can be used for creating the statistical model 224, as discussed in FIG. 2.

FIG. 4 is a flow diagram 400 illustrating a method for selecting at least one task template from one or the task templates in accordance with at least one embodiment. The flow diagram 400 is described in conjunction with FIG. 1, FIG. 2, and FIG. 3.

At step 402, the one or more task templates are received. The step 402 can further be understood by referring to step 302 of FIG. 3.

At step 404, the one or more performance features of one or more task templates are predicted. In an embodiment, the statistical model 224, after determining the statistical relationship, uses the regression technique to predict the one or more performance features of the one or more task templates. In an embodiment, the performance features are considered regress and the task features are considered regressor. A Generalized Linear Model (GLM) is then used to predict the performance features of the task templates. In an alternate embodiment, an extension of GLM, Generalized Additive Models for Location, Scale, and Shape (GAMLSS) is used for predicting the performance features. Various other methods, as discussed in FIG. 2 may also be used for regression. In an embodiment, a mean (μ) and a variance (σ) of the one or more performance features of the one or more task templates may be calculated by the statistical model 224.

At step 408, the at least one task template is selected. The at least one task template may be selected by the statistical model 224 based on the predicted performance features of the one or more task templates. For example, the statistical model 224 may select the at least one task template based on the highest value of the mean (μ), or the smallest value of the variance (σ).

At step 412, the statistical model 224 is updated. As more task features and performance features associated with the one or more task templates are obtained by the communication manager 214, the statistical model 224 can be updated based on these obtained features. In an embodiment, the selected at least one task template may be used for posting one or more crowdsourcing tasks to obtain more performance features and the task features, based on which the statistical model 224 may be updated.

In an embodiment, the values determined for the pre-defined set of cognitive features may be used to create the task template with a predictable performance for particular task feature. For example, various areas comprising the data to be processed may be highlighted in the task template to improve the performance of the crowdworkers and performance of the task template may be predicted as described above.

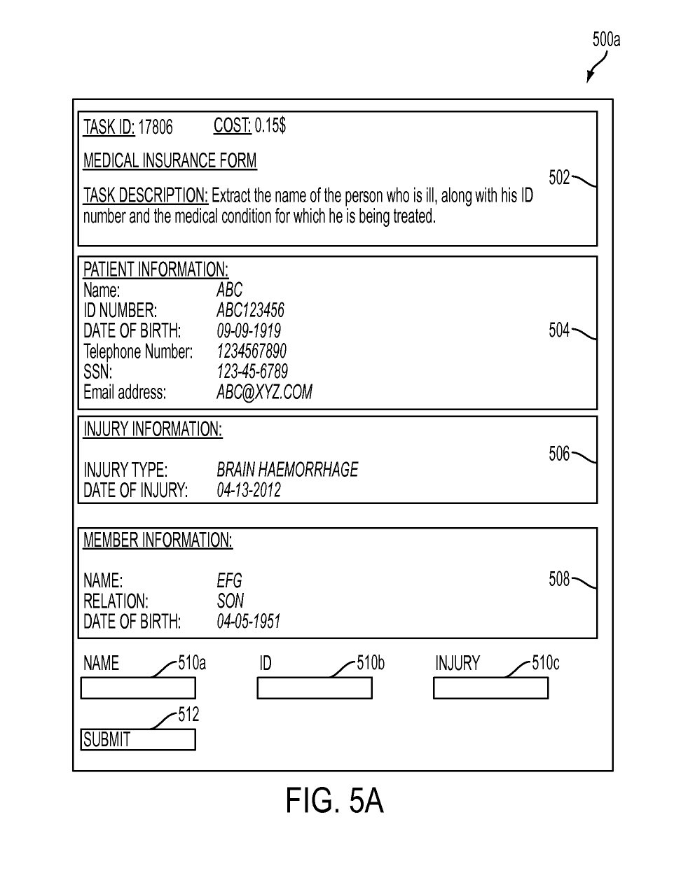

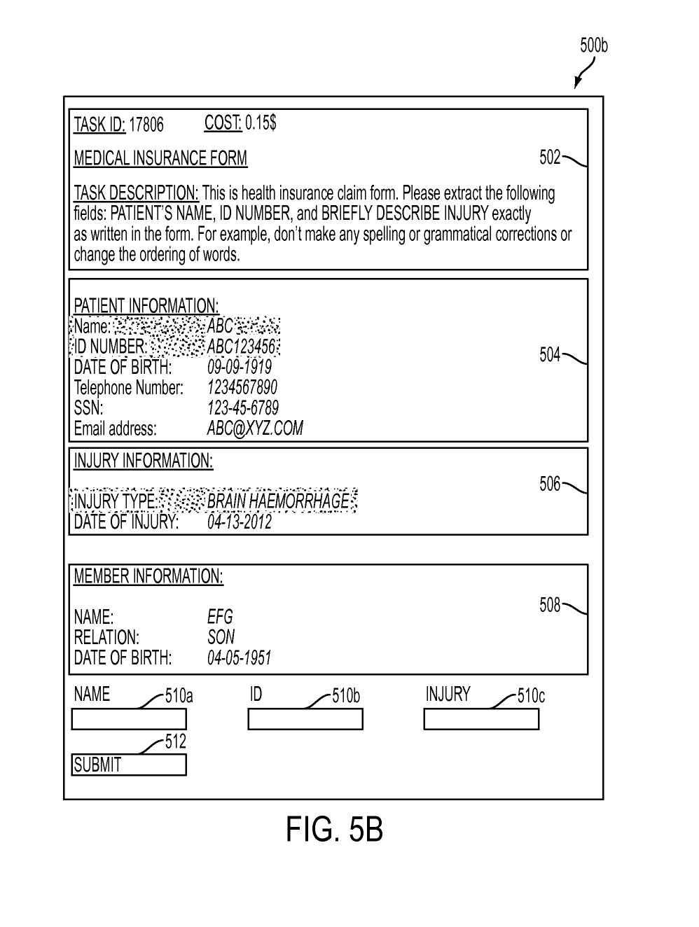

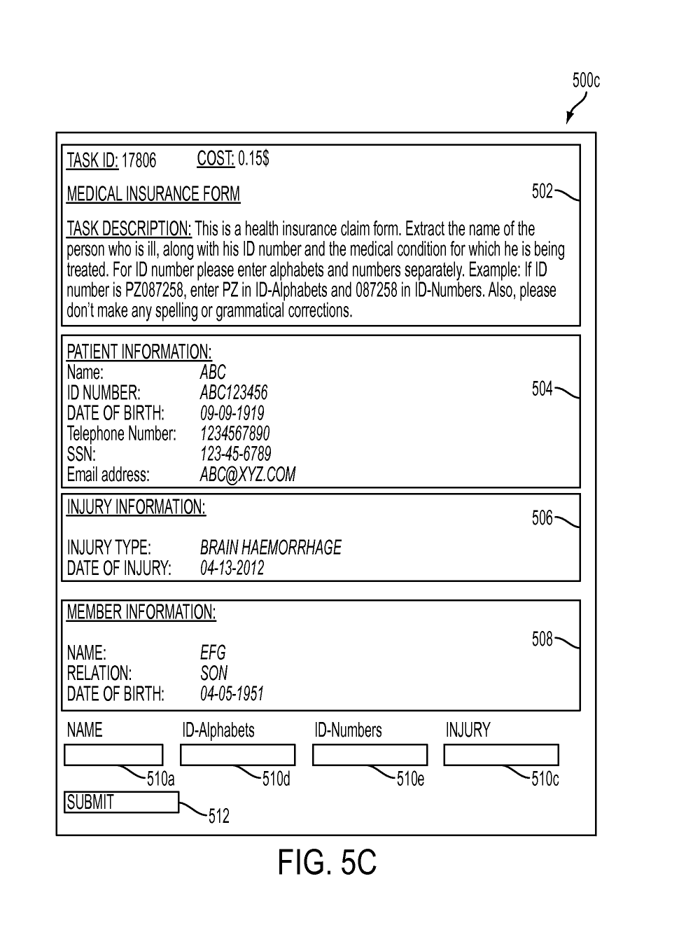

FIGS. 5A, 5B, and 5C illustrate example task templates 500a, 500b, and 500c in accordance with at least one embodiment. In an embodiment, the task templates 500a, 500b, and 500c correspond to a task of digitization of a medical insurance form having handwritten content. FIGS. 5A, 5B, and 5C will now be described in conjunction with FIG. 3 and FIG. 4.

In an embodiment, each of the templates 500a, 500b, and 500c comprise a task description section 502, a patient information section 504, an injury information section 506, a member information section 508, one or more response regions 510a, 510b (subdivided into regions 510d and 510e in the template 500b), and 510c, and a submit button 512. Hereinafter the response regions 510a, 510b, 510c, 510d, and 510e are collectively referred to as response regions 510.

The task description section 502 may include the information pertaining to the task such as task id, cost of the task, and instructions about how to perform the task. As depicted in FIG. 5A the information about how to perform the task in the task description section 502 of the template 500a is: “Digitize the name of the person who is ill, along with his ID number and the medical condition for which treatment is sought”. It can be seen that the information in the FIGS. 5B, and 5C has been changed in the templates 500b and 500c.

The patient information field 504 comprises the information pertaining to the patient such as name of the patient, ID number of the patient, date of birth of the patient, telephone number of the patient, SSN of the patient, and the email address of the patient. It is also depicted in the FIGS. 5A, 5B, and 5C that the information in patient information section 504 is handwritten, which the crowdworker is expected to digitize. Further, it can be observed that in the template 500b the fields: name of the patient and the ID numbers are highlighted.

The injury information section 506 comprises the information about the injury for which the insurance is being sought by the patient. As depicted in FIGS. 5A, 5B, and 5C, the injury information section 506 comprises the type of injury and date of occurrence of injury. It is also depicted that the field injury type has been highlighted in the template 500b.

The member information section 508 corresponds to the information about a member related to the patient. The information in the member information section 508 may include name of the member, relation of the member with the patient, and date of birth of the member.

The response regions 510 correspond to regions where the crowdworkers can provide responses corresponding to tasks. In an embodiment, the name of the patient, the ID number of the patient, and the injury type (e.g., as described by the injury information section 506) is identified by the crowdworkers and is provided in the response regions 510.

The submit button 512 may be used by the crowdworkers to submit the task. In an embodiment, after identifying the handwritten information (e.g., the name of the patient, the ID number, and the injury type), the crowdworker may use the submit button 512 to submit the task.

It would be understood by a person skilled in the art the statistical mode 224 corresponding to the templates 500a, 500b, and 500c may be learned using the method disclosed in FIG. 3. Historical data 226 (as illustrated in Table 1) corresponding to the templates 500a, 500b, and 500c may already be stored in the memory 208. Further, the values of the pre-defined set of cognitive features may be calculated for the task templates 500a, 500b, and 500c. Following table (Table 2) illustrates the calculated values of the cognitive features corresponding to the three task templates.

TABLE2
Illustration of the values of the pre-defined set of cognitive features

| Feature | Template 500a | Template 500b | Template 500c |
|---|---|---|---|
| X_{Sal} | 0.0058 | 0.25 | 0.0058 |
| X_{SearchEff} | 0.093 | 0.09375 | 0.1304 |
| X_{TDSim} | 0.95 | 0.95 | 0.324 |
| X_{DDSim} | 0.1 | 0.1 | 0.72 |
| X_{TaskDesSim} | 0.622 | 0.575 | 0.642 |
| X_{DK} | 0 | 1 | 0 |
| X_{WM} | 0 | 0 | 1 |

Table 2 may also be pre-stored in the memory 208 as the feature data 230. Now the method of selection of the at least one task template from task templates 500a, 500b, and 500c will be described in conjunction with FIG. 4.

For example, at step 402, the templates 500a, 500b, and 500c are received by the system 200 to select one of them for uploading the tasks on crowdsourcing platforms.

In accordance with step 404, the statistical model 224 predicts the one or more performance features associated with the task templates 500a, 500b, and 500c. In an embodiment, after determining the statistical relationship between the historical data 226 and the feature data 230, the statistical model 224 may use a regression technique to calculate the mean (μ) and the variance (σ) of the performance features associated with each of the template 500a, 500b, and 500c. It would be apparent to a person skilled in the art that various other statistical techniques may also be employed by the statistical model 224 to predict the performance features, as discussed in the description of FIG. 2.

In accordance with the 408, the statistical model 224 selects at least one task template (out of 500a, 500b, and 500) based on the predicted performance features. In an embodiment, the statistical model 224 selects the task template with the highest value of the mean (μ) of the accuracy values associated with the templates 500a, 500b, and 500c.

In accordance with step 412, the statistical model 224 may also be updated based on the one or more performance features and the one or more task features. In an embodiment, as more data pertaining to the task features or the performance features is obtained by the system 200, the statistical model 224 is updated. In an embodiment, with the updating of the statistical model 224, the prediction about the one or more performance features associated with the task templates may also be updated.

The disclosed embodiments encompass numerous advantages. Given the fact that the nature of communication between the requester and the crowdworkers is asynchronous, i.e., the tasks are uploaded by the requester using the task templates and are attempted by the crowdworkers at some point of time, there is less control on performance of the crowdworkers performing such tasks. In the disclosed embodiment, the design of the task template itself may be utilized for enhancing the performance of the crowdworkers. Based on the pre-defined set of cognitive features, the performance of any given task template may be predicted on one or more crowdsourcing platform servers. Further, a suitable template from the one or more task templates, with respect to one or more performance features, may be selected by the system.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer readable instructions may include various commands that instruct the processing machine to perform specific tasks such as, steps that constitute the method of the disclosure. The method and systems described can also be implemented using only software programming, or using only hardware, or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in all operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of a method and system for selecting at least one task template from one or more task templates have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method for selecting at least one task template from one or more task templates usable in one or more crowdsourcing tasks, the method comprising:
determining values of a pre-defined set of cognitive features associated with each of the one or more task templates; and
selecting the at least one task template based on the values of the pre-defined set of cognitive features and a statistical model maintained based on a historical data, wherein the historical data corresponds to at least one of one or more task features or one or more performance features associated with the one or more task templates,
wherein the method is performed by one or more processors.

2. The method of claim 1, wherein the pre-defined set of cognitive features comprises at least one of a saliency metric (X_{Sal}), a search efficiency metric (X_{SearchEff}), a target-distracter similarity (X_{TDSim}), a distracter-distracter similarity (X_{DDSim}), a task description similarity (X_{TaskDesSim}), a domain knowledge metric (X_{DK}) metric, or a working memory metric (X_{WM}).

3. The method of claim 1 further comprising uploading one or more sample crowdsourcing tasks corresponding to each of the one or more task templates to obtain the historical data.

4. The method of claim 1 further comprising predicting the one or more performance features of the one or more task templates for the one or more crowdsourcing tasks.

5. The method of claim 4, wherein the statistical model uses a regression technique to predict the one or more performance features of the one or more task templates.

6. The method of claim 1 further comprising updating the statistical model based on at least one of the one or more task features, the one or more performance features, or the values of the pre-defined set of cognitive features associated with the one or more task templates.

7. The method of claim 1, wherein the one or more task features comprise at least one of a day of submitting a crowdsourcing task, a time in the day of submitting the crowdsourcing task, a cost of the crowdsourcing task, or a country of crowdworker.

8. The method of claim 1, wherein the one or more performance features comprise at least one of an accuracy rate of a crowdsourcing task, a response time of the crowdsourcing task, or a completion rate of the crowdsourcing task.

9. The method of claim 1, wherein a crowdsourcing task comprises at least one of handwriting recognition, image labeling, language translation, or video labeling.

10. A method for predicting one or more performance features of one or more task templates usable in one or more crowdsourcing tasks, the method comprising:
receiving the one or more task templates corresponding to the one or more crowdsourcing tasks;
determining values of a pre-defined set of cognitive features associated with each of the one or more task templates;
determining a statistical relationship between the values of the pre-defined set of cognitive features and a historical data using a statistical model, wherein the historical data corresponds to at least one of one or more task features or the one or more performance features associated with the one or more task templates;
predicting the one or more performance features of the one or more task templates based on the determined statistical relationship; and
updating the statistical model based on at least one of the one or more task features, the one or more performance features, or the values of the pre-defined set of cognitive features associated with the one or more task templates,
wherein the method is performed by one or more processors.

11. A system for selecting at least one task template from one or more task templates usable in one or more crowdsourcing tasks, the system comprising:
a memory comprising:
a communication manager configured to receive the one or more task templates corresponding to the one or more crowdsourcing tasks;
a feature determination module configured to determine values of a pre-defined set of cognitive features associated with each of the one or more task templates; and
a statistical model configured to select the at least one task template based on the values of the pre-defined set of cognitive features and a historical data, wherein the historical data corresponds to at least one of one or more task features or one or more performance features associated with the one or more task templates, and
one or more processors configured to execute the communication manager, the feature determination module, and the statistical model.

12. The system of claim 11, wherein the pre-defined set of cognitive features comprises at least one of a saliency metric (X_{Sal}), a search efficiency metric (X_{SearchEff}), a target-distracter similarity (X_{TDSim}), a distracter-distracter similarity (X_{DDSim}), a task description similarity (X_{TaskDesSim}), a domain knowledge metric (X_{DK}), or a working memory metric (X_{WM}).

13. The system of claim 11, wherein the historical data is obtained based on one or more sample crowdsourcing tasks corresponding to each of the one or more task templates.

14. The system of claim 11 further comprising a training module configured to create the statistical model based on at least one of the one or more task features or the one or more performance features associated with the one or more task templates.

15. The system of claim 14, wherein the training module is further configured to update the statistical model based on at least one of the one or more task features, the one or more performance features, or the values of the pre-defined set of cognitive features associated with the one or more task templates.

16. The system of claim 11 further comprising a template manager configured to identify the pre-defined set of cognitive features in the one or more task templates.

17. The system of claim 11, wherein the statistical model is further configured to predict the one or more performance features of the one or more task templates for the one or more crowdsourcing tasks.

18. The system of claim 17, wherein the statistical model uses a regression technique to predict the one or more performance features of the one or more task templates.

19. The system of claim 11, wherein the one or more task features comprise at least one of a day of posting a crowdsourcing task, a time in the day of posting the crowdsourcing task, a cost of the crowdsourcing task, or a country of crowdworker.

20. A computer program product for use with a computer, the computer program product comprising a non-transitory computer readable medium, the non-transitory computer readable medium stores a computer program code for selecting at least one task template from one or more task templates usable in one or more crowdsourcing tasks, the computer program code performing a method, the method comprising:
determining values of a pre-defined set of cognitive features associated with each of the one or more task templates; and
selecting the at least one task template based on the values of the pre-defined set of cognitive features and a statistical model maintained based on a historical data, wherein the historical data corresponds to at least one of one or more task features or one or more performance features associated with one or more task templates.
